(19) United States
(12) Patent Application Publication
(10) Pub. No.: US 2014/0329537 A1
(43) Pub. Date: Nov. 6, 2014

(54) METHOD FOR DETERMINING A POSITION OF A ROUTER AND SYSTEM TEHROF

(71) Applicant: JUNG TANG HUANG, Taipei (TW)

(72) Inventor: JUNG TANG HUANG, Taipei (TW)

(21) Appl. No.: 13/887,326

(22) Filed: May 5, 2013

(51) Int. Cl. H04W 64/00

(52) U.S. Cl. CPC H04W 64/003
USPC 455/456.1

(57) ABSTRACT

The present invention provides a method for determining a position of a router having Bluetooth 4.0 or a later version communication function and WiFi communication function, comprising: providing a plurality of LED lamps each having Bluetooth 4.0 or a later version communication function; constructing a map comprising the locations of the plurality of LED lamps, and saving the map on a cloud server; periodically scanning in the router's Bluetooth communication range Bluetooth identifications (BTIDs) and received signal-strength indicators (RSSIs) of one or more of the plurality of LED lamps, and transmitting via WiFi the BTIDs and RSSIs to the cloud server; and determining the position of the router in the map based on BTIDs and RSSIs of at least three of the plurality of LED lamps by a triangulation method.

### TECHNOLOGY FIELD

The present invention relates to a method for determining a position of a router having Bluetooth 4.0 or a later version communication function and WiFi communication function, and a system thereof.

### BACKGROUND OF THE INVENTION

For companies, hospitals, and care institutions etc., there may be many departments distributed in a wide area. To communicate with or position people walking around, mobile phone is still more convenient. However, mobile phone requires higher fees and frequently electrical charging. On the other hand, remote care for people living alone cannot be effectively established since the installation of the network is complicated and its lack of human factor design. For example, remote care utilizing wireless sensor network technologies like ZIGBEE etc. Therefore, there is still a need for a better method for positioning, monitoring or interacting with a person at a remote site, and a system thereof.

### BRIEF SUMMARY OF THE INVENTION

In one aspect, the present invention provides a method for determining a position of a router having Bluetooth 4.0 or a later version communication function and WiFi communication function, the method comprising: providing a plurality of electric appliances each having Bluetooth 4.0 or a later version communication function; constructing a map comprising the locations of the plurality of electric appliances, and saving the map on a cloud server; periodically scanning in the router's Bluetooth communication range Bluetooth identifications (BTIDs) and received signal-strength indicators (RSSIs) of one or more of the plurality of electric appliances, and transmitting via WiFi the BTIDs and RSSIs to the cloud server; and determining the position of the router in the map based on BTIDs and RSSIs of at least three of the plurality of electric appliances by a triangulation method.

According to the present invention, the method may further comprise a step of: transmitting the position of the router in the map to the router, or a care personnel or a monitoring personnel.

In certain embodiments of the present invention, the router is a mobile device. Preferably, the mobile device is selected from the group consisting of a mobile phone, a wristband device, a headphone, a wearable computer, a laptop computer, and a tablet computer.

In another aspect, the present invention provides a system comprising: a router having Bluetooth 4.0 or a later version communication function and WiFi communication function; a plurality of electric appliances each having Bluetooth 4.0 or a later version communication function; and a cloud server for saving a map comprising the locations of the plurality of electric appliances; wherein the router periodically scans in its Bluetooth communication range Bluetooth identifications (BTIDs) and received signal-strength indicators (RSSIs) of one or more of the plurality of electric appliances, and transmitting via WiFi the BTIDs and RSSIs to the cloud server; and the cloud server determines the position of the router in the map based on BTIDs and RSSIs of at least three of the plurality of electric appliances by a triangulation method.

According to the present invention, the LED lamps each may be selected from the group consisting of an indoor light, an outdoor light, a ground light, and a street light.

It is believed that a person of ordinary knowledge in the art to which the present invention belongs can utilize the present invention to its broadest scope based on the descriptions herein with no need of further illustration. Therefore, the following descriptions should be understood as of demonstrative purpose instead of limitative in any way to the scope of the present invention.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 illustrates a basic triangulation method for used in the present invention.

FIG. 2 shows how the distances between a router and electric appliances of the present invention may be calculated using the RSSIs.

FIG. 3 illustrates an example of the construction a map comprising the locations of a plurality of electric appliances.

FIG. 4 shows relationships between RSSI and the distance.

FIG. 5 illustrates a setting of electric appliances of one embodiment of the present invention.

FIG. 6 illustrates another setting of electric appliances of one embodiment of the present invention.

FIG. 7 is a block diagram of a router according to one embodiment of the present invention.

FIG. 8 illustrates how the status of an electric appliance may be set according to its distance from a user.

### DETAILED DESCRIPTION OF THE INVENTION

Unless defined otherwise, all technical and scientific terms used herein have the same meanings as is commonly understood by one of skill in the art to which this invention belongs.

As used herein, the articles “a” and “an” refer to one or more than one (i.e., at least one) of the grammatical object of the article. By way of example, “an element” means one element or more than one element.

The present invention is further illustrated by the following descriptions, which are intended for mere demonstration and explanation but not limitation of the present invention to specific forms. The present invention envisions other variations in addition to those described herein. It is believed that those skilled in the art can achieve the whole scope of the present invention based on the descriptions herein.

In one aspect, the present invention provides a method for determining a position of a router having Bluetooth 4.0 or a later version communication function and WiFi communication function, the method comprising: providing a plurality of electric appliances each having Bluetooth 4.0 or a later version communication function; constructing a map comprising the locations of the plurality of electric appliances, and saving the map on a cloud server; periodically scanning in the router's Bluetooth communication range Bluetooth identifications (BTIDs) and received signal-strength indicators (RSSIs) of one or more of the plurality of electric appliances, and transmitting via WiFi the BTIDs and RSSIs to the cloud server; and determining the position of the router in the map based on BTIDs and RSSIs of at least three of the plurality of electric appliances by a triangulation method.

The router generally serves as an identification, allowing accurate positioning of a user and connection to the interne anytime anywhere.

The “WiFi” as used herein also refers to Wi-Fi Direct, which allows devices to communicate with each other without the real access point connection.

In preferred embodiments of the present invention, the method further comprises a step of: transmitting the position of the router in the map to the router, or a care personnel or a monitoring personnel. For remote care, the position of the router may be transmitted to a care personnel, for remote monitoring, the position of the router may be transmitted to a monitoring personnel, and for personal navigation, the position of the router may be transmitted back to the router itself. Accordingly, in one embodiment, the position of the router in the map is transmitted to the router for navigation.

According to the present invention, the router is preferably a mobile device. The mobile includes but is not limited to a mobile phone, a wristband device, a headphone, a wearable computer, a laptop computer, and a tablet computer. In preferred embodiments of the present invention, the router is carried by a user. However, the router may also be used as a fixed device. For example, the router may be fixed on a machine for monitoring.

In certain embodiments of the present invention, the BTIDs and RSSIs are first transmitted to a gateway, and then transmitted to the cloud sever.

According to the present invention, the electric appliances may each be a microwave oven, a lamp, a LED lamp, an electric cooker, an electric oven, an induction cooker, electric fan, a dehumidifier, an air cleaner, an air conditioner, a juice machine, a vacuum cleaner, a refrigerator, a dishwasher, a microwave oven, an electric curtain, an electric bed, an elevator, an electric door, or an electric massage chair. Preferably, the electric appliances are LED lamps. The LED lamps may each be an indoor light, an outdoor light, a ground light, or a street light.

In the case that the router is carried by a user, the method may further comprise a step of: collecting data provided by one or more wearable sensors worn on the user, and transmitting the data to the cloud server. The wearable sensors each may be selected from the group consisting of a plantar pressure sensor, a three-axis accelerometer, a gyroscope, a digital compass, an EEG sensor, an ECG sensor, a percutaneous sensor, an implantable sensor, an oximeter, a blood glucose meter, an EMG sensor, and a blood pressure monitor. For remote care, the position of the user and the user's physiological signals may be transmitted to the cloud sever and accessible by a care personnel.

In another aspect, the present invention provides a system comprising: a router having Bluetooth 4.0 or a later version communication function and WiFi communication function; a plurality of electric appliances each having Bluetooth 4.0 or a later version communication function; and a cloud server for saving a map comprising the locations of the plurality of electric appliances; wherein the router periodically scans in its Bluetooth communication range Bluetooth identifications (BTIDs) and received signal-strength indicators (RSSIs) of one or more of the plurality of electric appliances, and transmitting via WiFi the BTIDs and RSSIs to the cloud server; and the cloud server determines the position of the router in the map based on BTIDs and RSSIs of at least three of the plurality of electric appliances by a triangulation method.

In preferred embodiments of the present invention, the position of the router in the map may be further transmitted to the router, or a care personnel or a monitoring personnel. In one embodiment, the position of the router in the map is transmitted to the router for navigation.

According to the present invention, the router is preferably a mobile device. The mobile includes but is not limited to a mobile phone, a wristband device, a headphone, a wearable computer, a laptop computer, and a tablet computer. However, the router may also be used as a fixed device. For example, the router may be fixed on a machine for monitoring.

In certain embodiments of the present invention, the BTIDs and RSSIs are first transmitted to a gateway, and then transmitted to the cloud sever.

The electric appliances may each include a built-in Bluetooth 4.0 or a later version communication module to perform the Bluetooth 4.0 or a later version communication function. According to the present invention, the electric appliances may each be a microwave oven, a lamp, a LED lamp, an electric cooker, an electric oven, an induction cooker, electric fan, a dehumidifier, an air cleaner, an air conditioner, a juice machine, a vacuum cleaner, a refrigerator, a dishwasher, a microwave oven, an electric curtain, an electric bed, an elevator, an electric door, or an electric massage chair. Preferably, the electric appliances are LED lamps. The LED lamps may each be an indoor light, an outdoor light, a ground light, or a street light.

In the case that the router is carried by a user, the system may further comprise one or more wearable sensors worn on the user, wherein the router collects data provided by the one or more wearable sensors, and transmits the data to the cloud server. The wearable sensors each may be selected from the group consisting of a plantar pressure sensor, a three-axis accelerometer, a gyroscope, a digital compass, an EEG sensor, an ECG sensor, a percutaneous sensor, an implantable sensor, an oximeter, a blood glucose meter, an EMG sensor, and a blood pressure monitor.

Further, a microphone may also be configured on the router to allow the user to call for help and give an instruction to a Bluetooth controllable device.

On the other hand, through positioning the router and hence the user, the electric appliances may be configured to automatically turn on or turn off based on its relative position to the router.

The position of the router in the map is determined by the cloud server based on BTIDs and RSSIs of at least three of the plurality of electric appliances by a triangulation method. Accurate positioning can be achieved, for example, by the following steps:

(i) Bluetooth master node (the router) scanning at its maximum transceiver power level for Bluetooth slave nodes (electric appliances) in its Bluetooth reachable range;

(ii) determining a possible position of the Bluetooth master node in the scanning range by at least one set of three LED lights (more than one set of three LED lights may be used to improve the accuracy);

(iii) lowering the transmit power of the Bluetooth master node; and

(iv) doing the triangulation again.

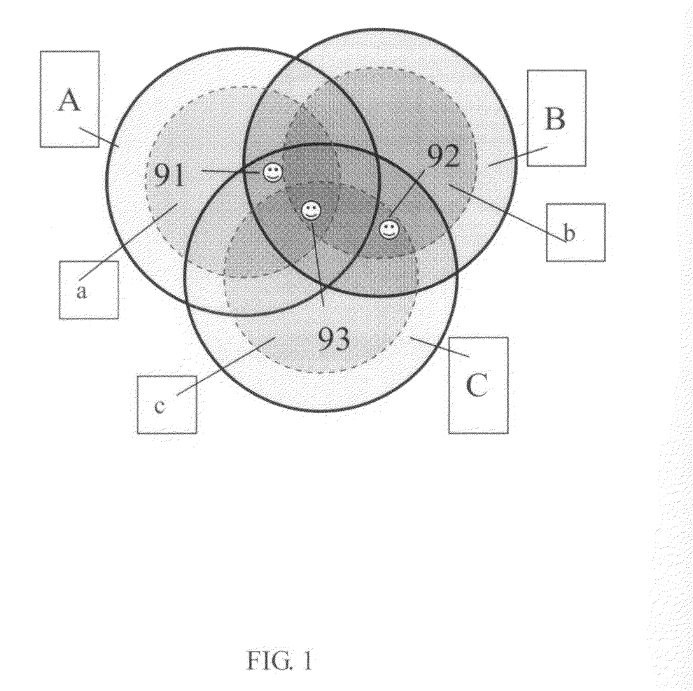

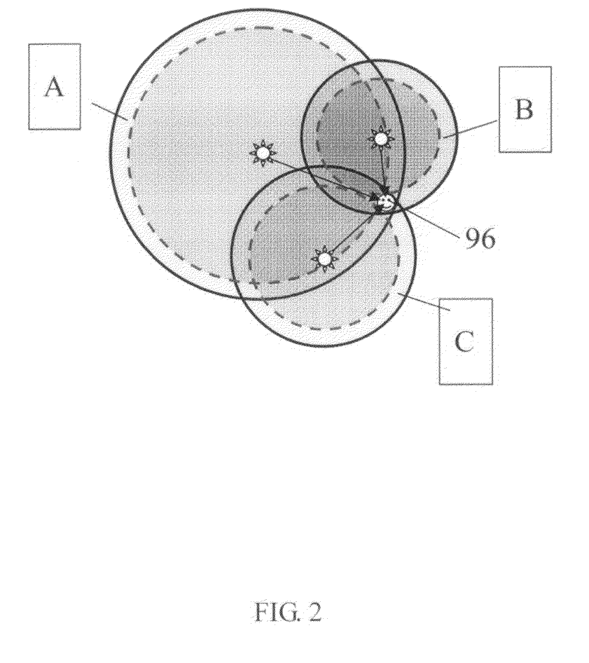

It is not necessary to lower the transmit power if the RSSIs are precise; however, common RSSI accuracy under a Bluetooth 4.0 protocol is ±6 dB. Therefore, the transmit power of the Bluetooth master node may be successively lowered as shown in Table 1 below to improve positioning accuracy. See FIGS. 1 and 2.

TABLE 1

| Power level of master node | Reachable range |
|---|---|
| +4 dBm | 35 m (open area) |
| 0 dBm | 30 m (open area) |
| −6 dBm | 15 m (open area) |
| −23 dBm | within 2 m |

FIG. 1 illustrates a basic triangulation method. The thick solid lines represent the reachable ranges at maximum power level, and the thin dashed lines represent the reachable ranges at half maximum power level. At maximum power scanning, user 91 and user 93 both appear in the intersection of circles A, B and C, while user 92 appears in the intersection of circles B and C, but not in the intersection of circles A, B and C. And at half maximum power scanning, user 93 appears in the intersection of smaller circles a, b and c with a higher accuracy of positioning, user 91 appears in the intersection of smaller circle a and A∩B∩C but not in smaller circle b nor c with a higher accuracy of positioning, and user 92 appears in b∩c but not circle A with also a higher accuracy of positioning. It can be understood that higher accuracy of positioning could be achieved when applying quarter (¼) maximum power scanning.

In addition, the distances between the router and the electric appliances may be calculated using the RSSIs. As shown in FIG. 2, the position of user 96 may be calculated based on the RSSI values acquired from the electric appliances A, B and C. electric appliances A, B and C are located at different places and each includes a built-in Bluetooth 4.0 slave node module to serve as a reference node for positioning. The router is carried by user 96 and may scan for the slave nodes to acquire their respective BTIDs and RSSIs.

For LED lamps mounted on a ceiling at the commanding height, effective line of sight (LOS) communication can be established between the router and the LED lamps without severe multipath transmission, thereby greatly enhance the positioning accuracy. Appropriate correction may be carried out according to the number of moving users. Models may also be established using a fuzzy inference method, or a neural network inference method etc. For example, for most of the lighting source having a distance from the ground of about two to four meters and a 3 m×5 m room or a 4 m×10 m living room, the positioning accuracy may be confined to within the size of the room (e.g. 0.5-1 m) using the above-mentioned successive scanning of, for example, maximum power, half maximum power, and quarter maximum power. Other electric appliances with built-in Bluetooth 4.0 or later version communication module may be used as reference slave nodes for correction by entering their corresponding BTIDs and 3D coordinates.

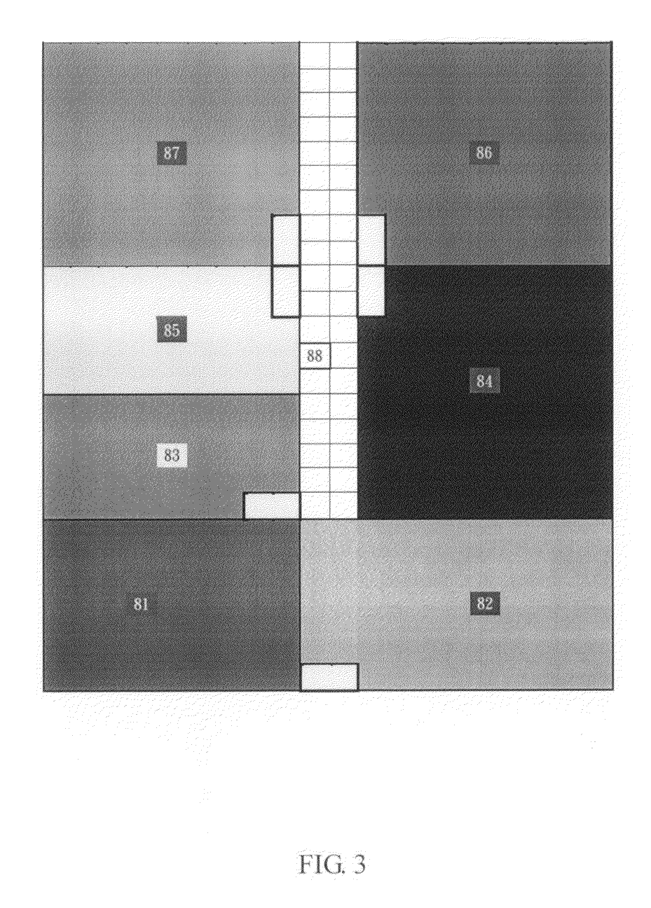

An example of the construction a map comprising the locations of the plurality of electric appliances is illustrated in FIG. 3. As shown in FIG. 3, a user may manually mark the locations of the LED lamps, e.g. restaurant light 81, living room light 82, kitchen room light 83, master bed room light 84, bathroom light 85, room 1 light 86, room 2 light 87, and aisle light 88. The height of the LED lamps may also be specified to enhance the positioning. The positions of other electric appliances with built-in Bluetooth 4.0 or later version communication module may also be marked. In addition, the positions of certain furniture, especially bed, may be marked to help a care personnel to determine if the user is in bed or is falling on the floor.

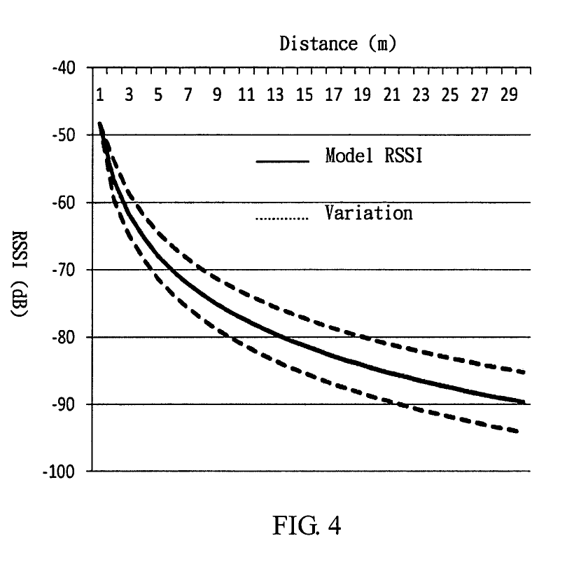

As shown in FIG. 4, relationships between RSSI and the distance should be established for each power level. Methods for spatial positioning by RSSI values acquired by scanning reference nodes may be found in “Enhanced RSSI-Based Real-Time User Location Tracking System for Indoor and Outdoor Environments,” Erin-Ee-Lin Lau and Wan-Young Chung, Dongseo University, Korea, 2007 International Conference on Convergence Information Technology, IEEE.

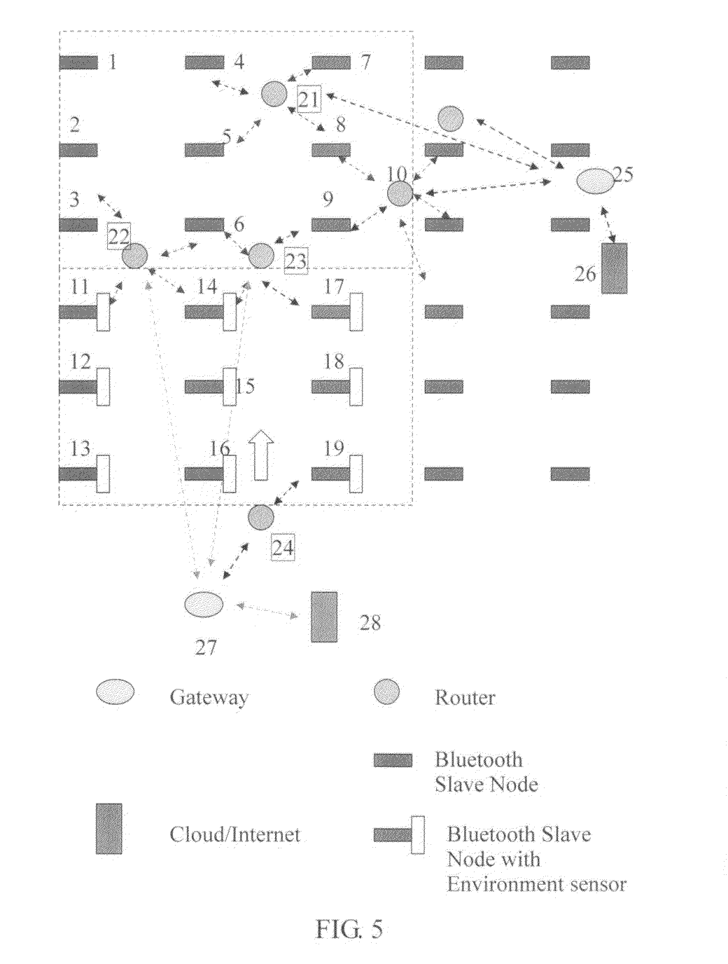

FIG. 5 illustrates a setting of LED lamps of one embodiment of the present invention. Each LED lamp is preferably built in a TI's CC2540/2541 chip module to serve as a Bluetooth slave node. On the other hand, one or more users each carries at least one router of the present invention, which has Bluetooth 4.0 or a later version communication function and WiFi communication function. Each router, as a Bluetooth master node, will periodically scan in its Bluetooth communication range for Bluetooth slave nodes of the LED lamps. The data of the Bluetooth slave nodes (e.g. Bluetooth identifications (BTIDs) and received signal-strength indicators (RSSIs)) obtained through scanning is collected and transmitted via WiFi to the interne or a cloud sever for position computation for the corresponding user.

Basically, each Bluetooth communication node has a unique BTID. In addition to constructing a three-dimensional map of the indoor or outdoor (e.g. different floors of a building) for positioning based on the LED lamps Bluetooth communication network, the present invention allows the user to control the brightness or color of the LED lamps with built-in Bluetooth 4.0 or a later version communication function. For example, when a user wishes to adjust a light source, he or she may connect the router with a nearby LED lamp and send out an instruction through the Bluetooth.

Connection times for Bluetooth 2.0 or 3.0 require a several seconds, which is much slower as compared to IR communication. While the connection interval for Bluetooth 4.0 is as short as 7.5 milliseconds (Texas Instruments CC2540 Bluetooth® Low Energy Software Developer's Guide v1.0, 2010). It basically complies with the formula below:

Effective Connection Time=(Connection Interval)*(1+(Slave Latency))

The Connection Interval can range from a minimum value of 6 (7.5 ms) to a maximum of 3200 (4.0s); The Salve Latency can range from a minimum of 0 to a maximum of 499.

Further, fast scanning is possible under a Bluetooth 4.0 protocol. Basically, the time for a master node to scan 40 slave nodes does not exceed one second. Therefore, it is possible to position not only a static router but also a moving router using the method of the present invention. On the contrary, Bluetooth 2.0 or 3.0, or ZIGBEE used in the prior art cannot effectively position a moving target.

In preferred embodiments of the present invention, TI's CC2540/2541 chips are used in the electric appliances. A CC2540/2541 SOC (Texas Instruments) includes a Bluetooth 4.0 communication module, an 8051 microprocessor, an ADC convertor, and eight sensing signal inputs which may be linked with environment sensors. Therefore, in certain embodiments of the present invention, the measured values from one or more environment sensors may be read by the router along with the BTID of a LED lamp, and transmitted to a cloud sever. The environment sensor include but is not limited to a gas sensor, an air-borne pathogen sensor, a thermometer, a hygrometer, a manometer, a light meter, a flow meter, and a flow meter, etc.

The gateway 27 as shown in FIG. 5 may be a PC, a wearable computer, a laptop computer, a wearable computer, a mobile phone, or a tablet computer which includes a built-in Bluetooth 4.0 and WiFi combo chip, allowing wired or wireless internet access and thus may serve as a gateway for linking to a cloud server.

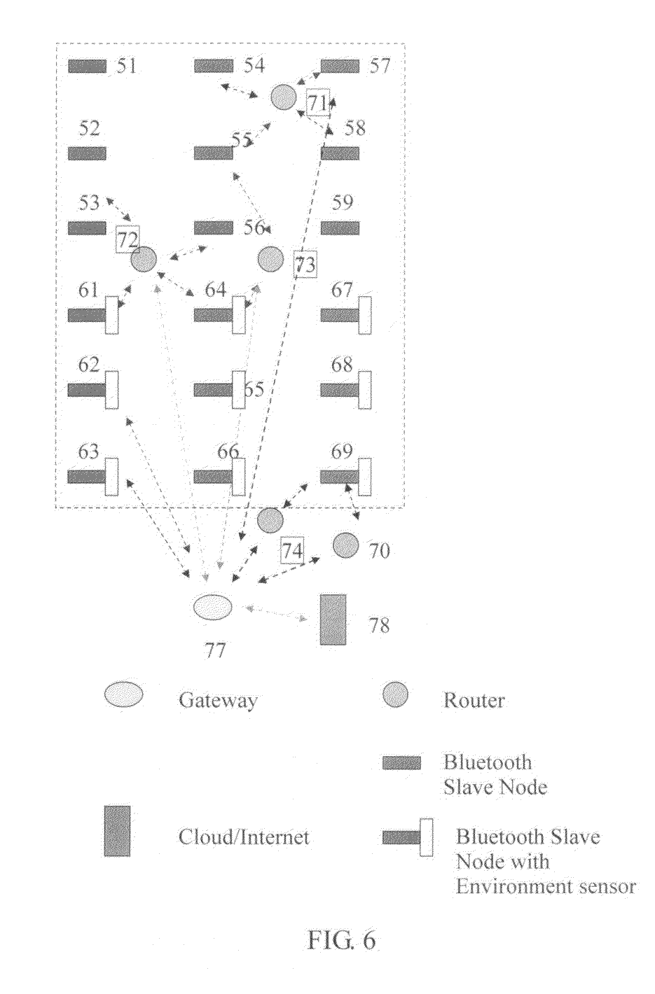

As shown in FIG. 6, if the electric appliances are set in a relatively small space compared to the Bluetooth communication range of 10-30 m, the gateway 77 with built-in Bluetooth 4.0 and WiFi combo chip may monitor or control through Bluetooth the electric appliances 51-59, or electric appliances, or sensors 61-69, or robots which each includes a Bluetooth node.

The “user” as used herein generally refers to a human, while also includes pets, animals, robots, machine or device, and vehicles.

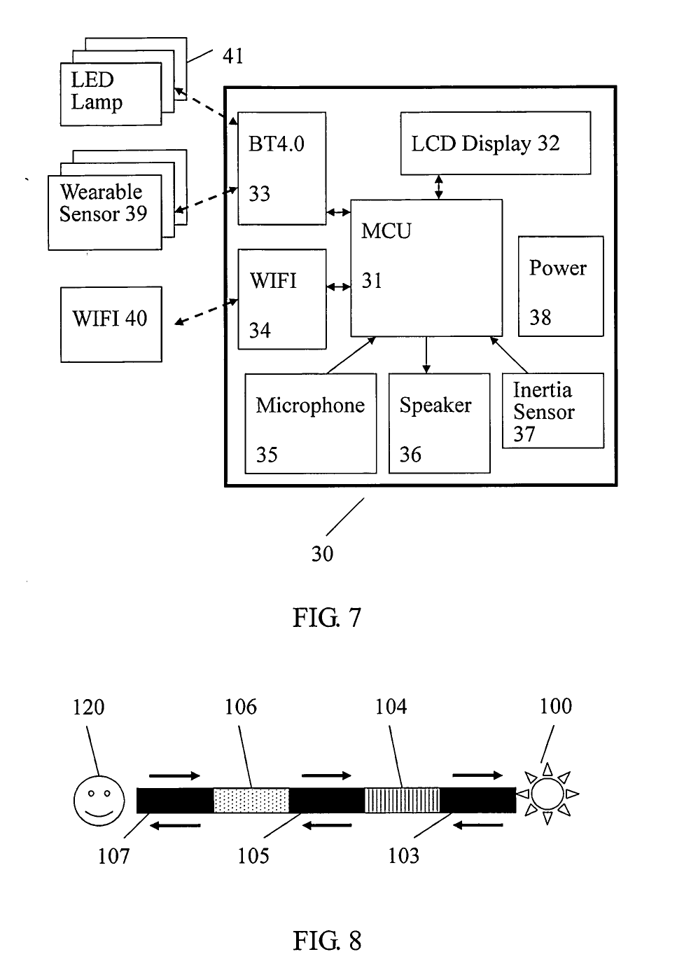

The block diagram of a router according to one embodiment of the present invention is shown in FIG. 7. As shown in FIG. 7, the router of the present invention preferably comprises the following elements/modules/features:

1. a wristband device 30 which is light, waterproof, and suitable for wearing in any occasion (the wrist strap appearance is not shown in the figure);

2. a microcontroller (or microprocessor) 31 as a control unit connected with the other circuit modules;

3. a monitor 32 which may be a LCD or a touch screen;

4. a Bluetooth 4.0 communication module 33 for identification which may communicates with one or more electric appliances 41 having Bluetooth 4.0 communication function, or one or more wearable sensors 39 with built-in Bluetooth 4.0 communication function;

5. a WiFi communication module 34 with adjustable transmission power, which may wirelessly connect to a cloud sever in a WiFi environment 40;

6. at least a microphone 35, allowing speech recognition input and output interface in combination with a cloud speech recognition (CSR) computation, which may be used to call for help by speech and may have a recording function;

7. a built-in speaker 36 (may also be in the form of a Bluetooth headphone) as a talking interface (like an interphone) through the cloud and wireless network;

8. being able to collecting data from surrounding environment sensors with built-in Bluetooth communication function, providing evidence helping determine whether there is harmful substance to human in the environment;

9. a power supply 38, preferably a battery; and

10. using low power consumption circuit components.

The router of the present invention may also comprises the following elements/modules/features:

1. a built-in inertia sensor 37 for recording the user's activity level;

2. a built-in heartbeat meter for measuring the user's activity intensity (not shown in the figure);

3. a vibration-generating module (not shown in the figure); and

4. being able to display time like a watch.

The router of the present invention may also be a mobile phone having Bluetooth 4.0 communication function, e.g. mobile phone supporting Android 4.0 or later protocol, HTC one V and X, etc., or iPhone 4S.

A user may also utilize the speech recognition function of the router to give an instruction for controlling electric appliances.

### Example 1

### Brightness or Color Adjustment Function (Referring to FIG. 5)

1. A wristband router or mobile phone (master node) scans for surrounding LED lamps having Bluetooth 4.0 slave nodes included therein, and displays on its monitor a user interface for selecting a setting one or more LED lamps in reachable range, e.g. LED lamp 7 is set to be green, LED lamp 2 is set to be red, LED lamp 8 is set to be blue, and LED lamp 9 is set to be yellow.

2. The router connects to LED lamps 7, 2, 8, and 9 successively or simultaneously to write the instructions to the Bluetooth 4.0 slave nodes. And then the microcontrollers will follow the instructions to change the color of LED.

### Example 2

### Positioning (Referring to FIG. 5 and FIG. 8)

Case I:

1. A router 21 scans for the BTIDs and RSSIs of the Bluetooth slave nodes of the surrounding LED lamps, e.g. LED lamps 4, 7, 5, and 8, or a router 21 scans for the BTIDs and RSSIs of the Bluetooth slave nodes of the surrounding LED lamps, e.g. LED lamps 3, 6, 11, and 14.

2. The BTIDs and RSSIs of the four Bluetooth slave nodes are transmitted by the router 21 via WiFi to a Wifi AP or a gateway 25, and then transmitted to the interne or a cloud server 28.

3. Cloud computation: based on a preset three-dimensional map comprising the locations of the Bluetooth slave nodes, the three-dimensional coordinates of the router 21 and router 22 are calculated by a triangulation method; and determine if the routers are located in a room of special properties, e.g. a bathroom or a kitchen, or located in a room which is secret or of control area.

4. The locations are transmitted back to the router 21 and the router 22 respectively, or transmitted to a care personnel or a monitor personnel for reference. Further, request for providing the measured values from the wearable sensors worn on the user or measured values from environment sensors on surrounding LED lamps may be made to the router 21 and the router 22.

Case II:

1. A router 23 scans for the BTIDs and RSSIs of the Bluetooth slave nodes of the surrounding LED lamps, e.g. LED lamps 6, 9, 14, and 17.

2. The BTIDs and RSSIs of the four Bluetooth slave nodes and measured values from the environment sensors on LED lamps 14 and 17 are transmitted by the router 21 via WiFi to a Wifi AP or a gateway 27, and then transmitted to the interne or a cloud server 28.

3. Cloud computation: based on a preset three-dimensional map comprising the locations of the Bluetooth slave nodes, the three-dimensional coordinate of the router 23 is calculated by a triangulation method; determine if the routers are located in a room of special properties, e.g. a bathroom or a kitchen, or located in a room which is secret or of control area; and determine based on the measured values from the environment sensors on LED lamps 14 and 17 whether the subject environment contains potential danger, e.g. an abnormally high level of carbon dioxide or carbon oxide in the air.

4. The location is transmitted back to the router 23, and to a care personnel or a monitor personnel for reference and handling.

Further App or program executable on the router may be designed to scan the RSSI values of surrounding LED lights when the user is getting up from bed or just moving in the night, allowing the router to connect with and read the closest LED light and determine if the brightness is appropriate or need to be adjusted. Other electric appliances may also be automatically adjusted or controlled in a similar way.

Through the method or system of the present invention, the position of a user carrying a router of the present invention can be determined and thus whether the user is nearby one or more on-site applied electric appliances (slave nodes) can also be determined. As shown in FIG. 8, based on the required time for cold start or warm start of an electric appliance 100 and the common walking of a user 120, the electric appliance 100 may be turned on or turned off according to the distance calculated or the RSSI. For example, the distances between the user 120 and the electric appliance 110 may be divided into long-distance area 107, first buffer area 106, mid-distance area 105, second buffer area 104 and short-distance area 103. Since the boot time of electric appliances such as TV, computer, or air conditioner is long, the start may be divided into cold start or warm start. Therefore, the status of such electric appliance may be set as below:

(A) when the position of the user 120 is within the short-distance area 103, the electric appliance 100 is set to be in an active state for use;

(B) when the position of the user 120 is within the mid-distance area 105, the electric appliance 100 is set to be in a warm start standby state;

(C) when the position of the user 120 is within the long-distance area 107, the electric appliance 100 is set to be in a shutdown state;

(D) when the position of the user 120 is within the first buffer area 106, go to (B) or (C) based on the moving direction of the user 120; and

(E) when the position of the user 120 is within the second buffer area 104, go to (A) or (B) based on the moving direction of the user 120.

### Example 3

### Map and Navigation (Referring to FIG. 5)

1. If a user carrying a router 24 sets on the router 24 that he or she wish to go to the position of LED lamp 7, a cloud server 28 first accesses the positioning information of the user of being around between LED lamps 16 and 19, and then provides a best path of going north (upward in the figure), and continuously positioning the user and providing instructions until the user reaches the position of LED lamp 7.

2. When a user carrying a router of the present invention or robot carrying a router of the present invention going into a new building, the router may first request or acquire a “BTID map” (a map comprising the locations of LED lamps with built-in Bluetooth 4.0 or later version communication function) of the new building, and then start the positioning or navigation as described above.

The above-disclosed preferred embodiments of the present invention are not intended as limitations to the present invention. Those skilled in the art of the present invention should be able to make changes and modifications within the spirit and scope of the present invention, and such changes and modifications would fall within the protected scope of the present invention as defined by the appended claims.

What is claimed is:

1. A method for determining a position of a router having Bluetooth 4.0 or a later version communication function and WiFi communication function, the method comprising:
providing a plurality of electric appliances each having Bluetooth 4.0 or a later version communication function;
constructing a map comprising the locations of the plurality of electric appliances, and saving the map on a cloud server;
periodically scanning in the router's Bluetooth communication range Bluetooth identifications (BTIDs) and received signal-strength indicators (RSSIs) of one or more of the plurality of electric appliances, and transmitting via WiFi the BTIDs and RSSIs to the cloud server; and
determining the position of the router in the map based on BTIDs and RSSIs of at least three of the plurality of electric appliances by a triangulation method.

2. The method of claim 1, further comprising a step of:
transmitting the position of the router in the map to the router, or a care personnel or a monitoring personnel.

3. The method of claim 2, wherein the position of the router in the map is transmitted to the router for navigation.

4. The method of claim 1, wherein the router is a mobile device.

5. The method of claim 4, wherein the mobile device is selected from the group consisting of a mobile phone, a wristband device, a headphone, a wearable computer, a laptop computer, and a tablet computer.

6. The method of claim 1, wherein the BTIDs and RSSIs are first transmitted to a gateway, and then transmitted to the cloud sever.

7. The method of claim 1, wherein the electric appliances each may be selected from the group consisting of a microwave oven a lamp, a LED lamp, an electric cooker, an electric oven, an induction cooker, electric fan, a dehumidifier, an air cleaner, an air conditioner, a juice machine, a vacuum cleaner, a refrigerator, a dishwasher, a microwave oven, an electric curtain, an electric bed, an elevator, an electric door, and an electric massage chair.

8. The method of claim 1, wherein the router is carried by a user.

9. The method of claim 8, further comprising a step of:
the router collecting data provided by one or more wearable sensors worn on the user, and transmitting the data to the cloud server.

10. The method of claim 9, wherein the one or more wearable sensors each may be selected from the group consisting of a plantar pressure sensor, a three-axis accelerometer, a gyroscope, a digital compass, an EEG sensor, an ECG sensor, a percutaneous sensor, an implantable sensor, an oximeter, a blood glucose meter, an EMG sensor, and a blood pressure monitor.

11. A system comprising:
a router having Bluetooth 4.0 or a later version communication function and WiFi communication function;
a plurality of electric appliances each having Bluetooth 4.0 or a later version communication function; and
a cloud server for saving a map comprising the locations of the plurality of electric appliances;
wherein the router periodically scans in its Bluetooth communication range Bluetooth identifications (BTIDs) and received signal-strength indicators (RSSIs) of one or more of the plurality of electric appliances, and transmitting via WiFi the BTIDs and RSSIs to the cloud server; and the cloud server determines the position of the router in the map based on BTIDs and RSSIs of at least three of the plurality of electric appliances by a triangulation method.

12. The system of claim 11, wherein the position of the router in the map is transmitted to the router, or a care personnel or a monitoring personnel.

13. The system of claim 12, wherein the position of the router in the map is transmitted to the router for navigation.

14. The system of claim 11, wherein the router is a mobile device.

15. The system of claim 14, wherein the mobile device is selected from the group consisting of a mobile phone, a wristband device, a headphone, a laptop computer, a wearable computer, and a tablet computer.

16. The system of claim 11, wherein the BTIDs and RSSIs are first transmitted to a gateway, and then transmitted to the cloud sever.

17. The system of claim 11, wherein the electric appliances each may be selected from the group consisting of a microwave oven, a lamp, a LED lamp, an electric cooker, an electric oven, an induction cooker, electric fan, a dehumidifier, an air cleaner, an air conditioner, a juice machine, a vacuum cleaner, a refrigerator, a dishwasher, a microwave oven, an electric curtain, an electric bed, an elevator, an electric door, and an electric massage chair.

18. The system of claim 11, wherein the router is carried by a user.

19. The system of claim 18, further comprising one or more wearable sensors worn on the user, wherein the router collects data provided by the one or more wearable sensors, and transmits the data to the cloud server.

20. The system of claim 19, wherein the one or more wearable sensors each may be selected from the group consisting of a plantar pressure sensor, a three-axis accelerometer, a gyroscope, a digital compass, an EEG sensor, an ECG sensor, a percutaneous sensor, an implantable sensor, an oximeter, a blood glucose meter, an EMG sensor, and a blood pressure monitor.
